(19) United States
(12) Patent Application Publication
(10) Pub. No.: US 2010/0253459 A1
(43) Pub. Date: Oct. 7, 2010

(54) Inductor Having Separate Wire Segments

(76) Inventors: Alan W. Zimmerman, Richmond, IL (US); Matthew W. Sweeney, Ringwood, IL (US)

Correspondence Address: QUARLES & BRADY LLP, 411 E. WISCONSIN AVENUE, SUITE 2040, MILWAUKEE, WI, 53202-4497, US

(21) Appl. No.: 12/753,283

(22) Filed: Apr. 2, 2010

Related U.S. Application Data
(60) Provisional application No. 61/166,566, filed on Apr. 3, 2009.

(51) Int. Cl. H01F 27/28

(52) U.S. Cl. 336/180

(57) ABSTRACT

An inductor is disclosed that comprises a magnetic core that includes at least one core segment. The inductor further comprises a plurality of separate conductive wire segments that together form a current path around at least a portion of the magnetic core. Each segment forms a turn around a portion of the magnetic core and the segments are connected end-to-end to form the current path. A first of the plurality of wire segments includes a first leg and a second leg. A second of the plurality of wire segments includes a first leg adjacent the first leg of the first wire segment but not in electrical contact therewith. The second wire segment further includes a second leg adjacent the second leg of the first wire segment but not in electrical contact therewith. The second leg of the second wire segment is in electrical contact with the first leg of the first wire segment to electrically connect the first and second wire segments.

### CROSS-REFERENCE TO RELATED APPLICATION

This application claims the benefit of U.S. Provisional Patent Application No. 61/166,566 filed Apr. 3, 2009, the disclosure of which is hereby incorporated by reference for all purposes.

### STATEMENT CONCERNING FEDERALLY SPONSORED RESEARCH OR DEVELOPMENT

Not Applicable.

### FIELD OF THE INVENTION

The present invention relates to inductors, specifically inductors having separate wire segments and capable of carrying high currents.

### BACKGROUND OF THE INVENTION

Inductors are well-known components that are found in various types of electrical circuits. In some cases, inductors are used with other components, such as capacitors, to form a circuit that filters certain signal frequencies. In other applications, multiple different inductors are used together to form a transformer that converts voltages.

Inductors include a conductive wire, often made of copper, that carries an electrical current and wraps around a ferromagnetic core, often of a toroidal shape. The inductance of the inductor is determined by the magnetic properties of the core and the number of turns of the wire wrapped around the core. Some inductors include a large number of turns; for example, inductors that use a small wire gauge may include several hundred turns. As a result, various winding machines are known in the art for accurately forming inductors in a short amount of time.

In some situations, such as converter applications, inductors need to carry a large amount of current. However, the current-carrying capacity of an inductor is limited in part by the size of the wire. As a result, larger inductors having larger wires are typically used in high-current situations. Unfortunately, the size of inductors that may be produced easily is limited to certain sizes. For example, inductors having 7-gauge wire or larger can only be formed using specific winding machines provided the ferromagnetic core has a sufficiently large internal diameter.

To address the aforementioned current-carrying limitations, some inductors are multi-filar type inductors that comprise two or more individual wires (inductors with two wires are bi-filar, three are tri-filar, and so on) that wind around the core in parallel. However, the wires typically include overlapping portions in order to achieve satisfactory inductance values. Unfortunately, the overlapping wire portions cause parasitic coupling of high frequency noise. In addition, the direct current resistance of most multi-filar inductors is relatively low and, labor-intensive hand-winding must be used for manufacturing such inductors. This process is relatively slow and the resulting products may have more defects due to operator error.

Considering the limitations of previous inductor designs, a need exists for an inductor that is appropriate for larger wire gauges and carries higher currents. Further still, a need exists for such an inductor that is relatively small and easily manufactured.

### SUMMARY OF THE INVENTION

In one aspect, the present invention provides an inductor comprising a magnetic core that includes at least one core segment. The inductor further comprises a plurality of separate conductive wire segments that together form a current path around at least a portion of the magnetic core. Each segment forms a turn around a portion of the magnetic core and the segments are connected end-to-end to form the current path. A first of the plurality of wire segments includes a first leg and a second leg. A second of the plurality of wire segments includes a first leg adjacent the first leg of the first wire segment but not in electrical contact therewith. The second wire segment further includes a second leg adjacent the second leg of the first wire segment but not in electrical contact therewith. The second leg of the second wire segment is in electrical contact with the first leg of the first wire segment to electrically connect the first and second wire segments.

In another aspect of the invention, the inductor comprises a magnetic core that includes at least one core segment. The magnetic core also has an outer surface, an inner surface, an upper surface that connects the outer surface and the inner surface, and a lower surface opposite the upper surface. The inductor further comprises a plurality of separate conductive wire segments that form a current path around at least part of the magnetic core. A first of the plurality of wire segments forms a first turn in the current path. The first turn proceeds from a first leg, extends around a portion of the magnetic core defined by the lower surface, the inner surface, the upper surface, and the outer surface, and ends at a second leg proximate the first leg. A second of the plurality of wire segments forms a second turn in the current path. The second turn proceeds from a first leg, extends around another portion of the magnetic core defined by the lower surface, the inner surface, the upper surface, and the outer surface, and ends at a second leg proximate the first leg of the second wire segment. The second leg of the second wire segment is electrically connected to the first leg of the first wire segment.

In yet another aspect of the invention, the inductor comprises a magnetic core that includes at least one core segment. The inductor further comprises a plurality of separate conductive wire segments that form a current path around at least a portion of the magnetic core, and each of the wire segments includes a first leg and a second leg. The inductor further comprises an insulating base that includes a plurality of holes to accommodate the first and second legs of the wire segments. At least some of the holes each accommodate and permit contact between the first leg of one wire segment and the second leg of an adjacent wire segment to electrically connect the one wire segment and the adjacent wire segment.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a perspective view of an inductor of the present invention;

FIG. 2 is a perspective view of the inductor of FIG. 1 showing a base of the inductor;

FIG. 3 is a side view of the inductor of FIG. 1;

FIG. 4 is a top view of the inductor of FIG. 1;

FIG. 5 is a bottom view of the inductor of FIG. 1;

FIG. 6 is a perspective view of an inductor sub-assembly after a wire segment engages a core;

FIG. 7 is a perspective view of an inductor sub-assembly after a plurality of wire segments engage the core of FIG. 6;

FIG. 8 is a perspective view of an inductor sub-assembly after a base connects to legs of the wire segments;

FIG. 9 is a detail view of the area enclosed by line 9-9 of FIG. 2 showing the legs and double-leg supports;

FIG. 10 is a perspective view of a double-leg support of the inductor of FIG. 1;

FIG. 11 is a perspective view of a single-leg support of the inductor of FIG. 1;

FIG. 12 is a perspective view of a second embodiment of the inductor of the present invention;

FIG. 13 is a perspective view of the inductor of FIG. 12 showing the base and the legs of the wire segments;

FIG. 14 is a side view of the inductor of FIG. 12;

FIG. 15 is a top view of the inductor of FIG. 12;

FIG. 16 is a bottom view of the inductor of FIG. 12; and

FIG. 17 is a perspective view of a single wire segment of the inductor of FIG. 12.

### DETAILED DESCRIPTION OF THE PREFERRED EMBODIMENT

The particulars shown herein are by way of example and only for purposes of illustrative discussion of the embodiments of the invention. The particulars shown herein are presented to provide what is believed to be the most useful and readily understood description of the principles and conceptual aspects of the invention. In this regard, no attempt is made to show structural details of the invention in more detail than is necessary for the fundamental understanding of the invention. The description taken with the drawings should make apparent to those skilled in the art how the several forms of the present invention may be embodied in practice.

In some cases, the reference numerals below include letters to distinguish between different components of the same type. For example, a first wire segment is designated 14a, an adjacent wire segment is designated 14b, and so on. However, the last component of the same type is distinguished with the letter “n”. For example, the last wire segment is designated 14n; it should be understood that there are not necessarily fourteen different components of the same type when the letter “n” is used.

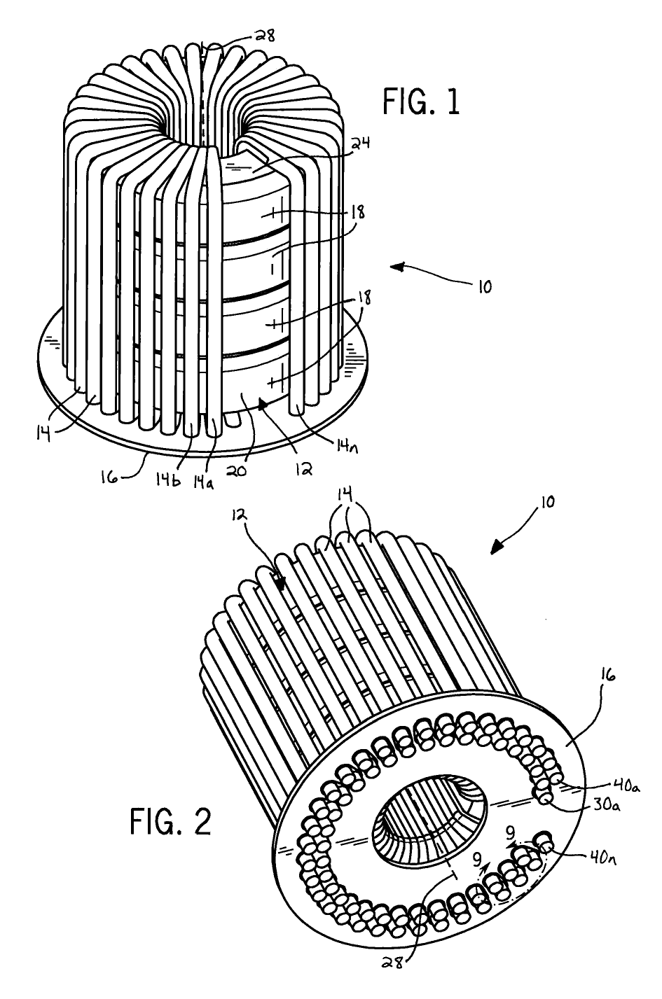

Referring to FIGS. 1-5, an inductor 10 of the present invention includes a magnetic core 12 surrounded by a plurality of electrically connected wire segments 14. A base 16 near a lower end of the magnetic core 12 supports the wire segments 14. In general, the core 12 and the base 16 have toroidal shapes, and as a result, the inductor 10 has a toroidal shape as shown in the figures; however, other shapes may also be used without departing from the scope of the invention. Other features of the aforementioned components are described in further detail below, starting with the magnetic core 12 and then proceeding to the wire segments 14 and the base 16.

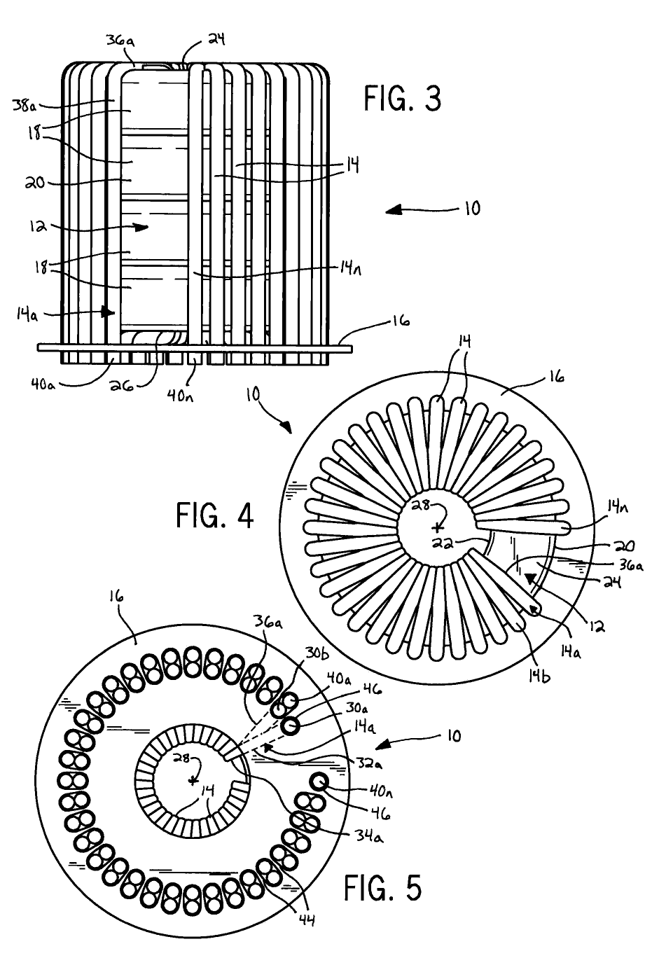

The magnetic core 12 is a ferromagnetic material that includes one or more stacked core segments 18; that is, the core 12 may include multiple core segments 18 but is not limited to four core segments 18 as shown in FIGS. 1-5. In a preferred embodiment, each core segment 18 has a toroidal shape, and as a result, the core 12 has outer and inner radial surfaces 20 and 22 (FIG. 4). Upper and lower axial surfaces 24 and 26 (FIGS. 3, 4, and 6) connect the radial surfaces 20 and 22. These surfaces define a longitudinal axis 28 of the inductor 10. Other features and characteristics of the magnetic core 12 may be such as those of any well-known core design.

The wire segments 14 carry a current in a helical path about the core 12. It should be understood that the wire segments 14 are separate components in contrast to a single continuous wire. However, it is contemplated that the wire segments 14 may be connected to one another by means as such soldering, crimping, and the like, as described in further detail below. In these cases, the wire segments 14 are still considered separate components.

The wire segments 14 are preferably disposed about the core 12 so that an opening isolates first and last wire segments 14a and 14n and ensures the current path does not short-circuit. As viewed in FIG. 4, the opening is preferably at least 30 degrees. In addition, the wire segments 14 are preferably made from copper having an insulating coating on most surfaces to ensure the current path does not short-circuit. The wire segments 14 do not have the insulating coating within and below the base 16 so that the segments can electrically connect to each other and thereby form the current path. This aspect is described in further detail below.

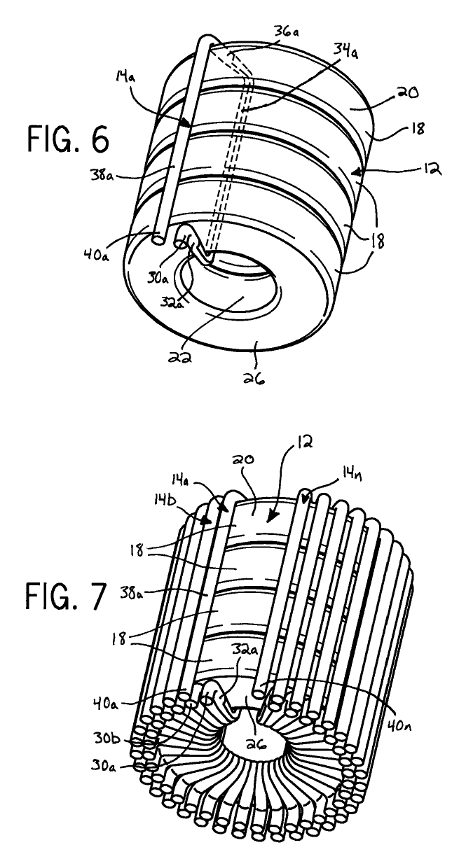

Referring now to FIGS. 4-7 and particularly FIG. 6, the first wire segment 14a includes a first leg 30a that connects to an electrical lead (not shown) or another appropriate component of the circuit in which the inductor 10 is used. A lower length 32a adjacent the lower surface 26 of the core 12 extends generally perpendicularly from the first leg 30a. An inner length 34a adjacent the inner surface 22 of the core 12 extends generally perpendicularly from the lower length 32a and in the direction of the longitudinal axis 28. As shown in the figures, the inner length 34a preferably has about the same height as the outer and inner radial surfaces 20 and 22 of the core 12.

An upper length 36a adjacent the upper surface 24 of the core 12 extends generally perpendicularly from the inner length 34a; however, the upper length 36a defines an angle with the lower length 32a as most clearly shown in FIG. 5. As a result, an outer length 38a and a second leg 40a that extend perpendicularly from the upper length 36a are angularly offset from the first leg 30a. The second leg 40a is also radially offset from the first leg 30a, or stated another way, positioned radially outwardly from the first leg 30a. The offset permits the first leg 30b of the adjacent wire segment 14b (FIGS. 5 and 7) to contact the second leg 40a and electrically connect to the first wire segment 14a. The first and second legs 30b and 40a preferably have longitudinal side surfaces that are in contact with each other, as shown in the figures, in contrast to the circular end surfaces of each wire segment 14. In some embodiments, the first and second legs 30b and 40a may be soldered or crimped below the base 16 to ensure the legs 30b and 40a remain in contact.

The adjacent wire segment 14b is identical to the first wire segment 14a, which should be understood to mean that the wire segments 14a and 14b are formed in the same manner, although minor structural differences may be present due to manufacturing uncertainty. Additional identical wire segments 14 complete the current path and electrically connect to adjacent segments 14 in the same manner; i.e., through contact of a pair of first and second legs 30 and 40. Each pair of first and second legs 30 and 40 may contact or connect to one another as described above. However, the second leg 40n of the last wire segment 14n connects to an electrical lead (not shown) or another appropriate circuit component.

From the above paragraphs it should be apparent that each separate wire segment 14 forms a turn in the helical current path of the inductor 10. Each turn proceeds from the first leg 30, extends around a portion of the core 12 defined by the lower surface 26, the inner surface 22, the upper surface 24, and the outer surface 20, and ends at the second leg 40 proximate the first leg 30. In the context of the first and second legs 30 and 40, the term “proximate” should be understood to mean that the first and second legs 30 and 40 are positioned near a common surface of the core 12 (e.g., the lower surface 26) and are offset from each other to permit contact with adjacent wire segments 14 as described above. This structure advantageously provides an inductor 10 in which components in addition to the wire segments 14 are not needed to form the helical current path, thereby simplifying assembly. In addition, the position of all the first and second legs 30 and 40 near the lower surface 26 of the core 12 simplifies additional manufacturing processes, such as crimping and soldering, by permitting these processes to be performed on the same side of the inductor 10.

The surfaces of each wire segment 14 that lie parallel to the longitudinal axis 28 are flattened or “pinched” to permit the segments 14 to be positioned closely to each other. In this context, the phrase “positioned closely” should be understood to mean that the wire segments 14 are positioned in a manner that would not be possible for wire segments without pinched surfaces. Stated differently, the outer lengths 38 define a nominal dimension (e.g., the diameter) of the wire segments 14, and centers of adjacent pinched surfaces are spaced apart by a distance less than the nominal dimension. In some embodiments and as shown in the figures, the surfaces of the inner lengths 34 and part of the surfaces of the lower and upper lengths 32 and 36 are pinched. In these embodiments, the pinched surfaces permit more wire segments 14 to be positioned about the magnetic core 12 in one uniform layer compared to wire segments without pinched surfaces. As a result, an inductor 10 with pinched wire segments 14 in one uniform layer has increased inductance, lower temperature rise, and may have a smaller size compared to an inductor without pinched wire segments in one uniform layer. Other characteristics of pinched wire inductors are described in U.S. Pat. No. 7,154,368, the disclosure of which is hereby incorporated by reference.

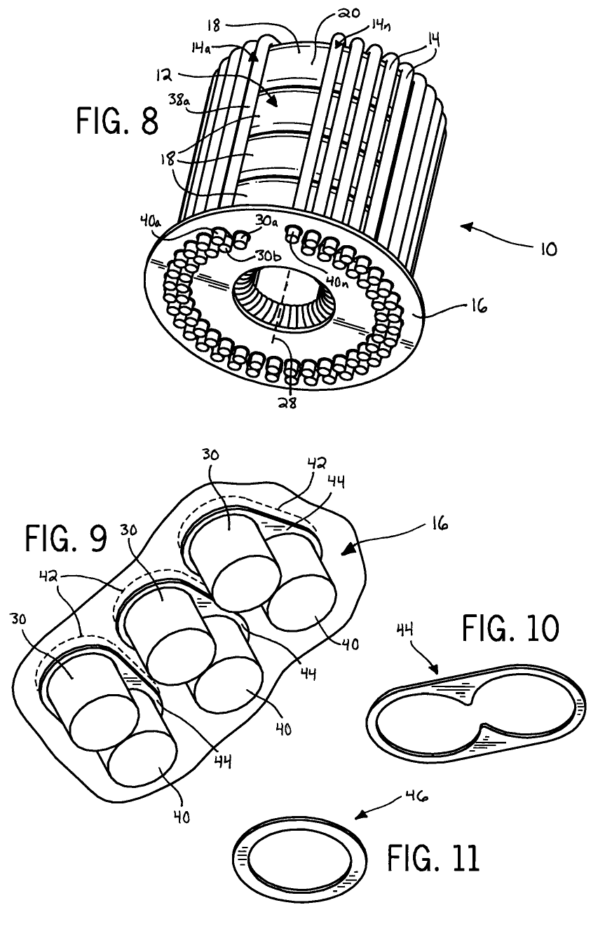

Referring now to FIGS. 8-11, the base 16 supports the first and second legs 30 and 40 of the wire segments 14 and is preferably an insulator to prevent short-circuiting of the inductor 10. A plurality of holes 42 that define a portion of a circle in the base 16 each accommodate a double leg support 44 (shown separately in FIG. 10) or a single leg support 46 (shown separately in FIG. 11). As the names imply, each double leg support 44 accommodates a pair of first and second legs 30 and 40, and each single leg support 46 accommodates either the first leg or the second leg 30a or 40n of the end wire segments 14a or 14n. The double leg supports 44 may be conductors to ensure an electrical connection is maintained if the legs move from contact with each other, or in some embodiments, the legs may be designed such that the double legs supports 44 provide the means for soldering an electrical connection instead of direct contact between the legs.

Referring again to FIGS. 6-8, the inductor 10 is preferably manufactured as follows. First, the wire segments 14 are bent to form the loop shape as shown in the figures. In some embodiments, some parts of the wire segments 14, such as the inner lengths 34, are then pinched to permit the wire segments 14 to be positioned closely to one another. Next, the wire segments 14 are positioned about the magnetic core 12 as shown in FIGS. 6 and 7. The base 16 is then positioned to accommodate the legs 30 and 40 of the wire segments 14 as shown in FIG. 8. Finally, in some embodiments, pairs of first and second legs 30 and 40 are soldered or crimped below the base 16.

The inductor 10 manufactured as described above provides improvements over conventional inductors that can be concentrated in one parameter, such as inductance, or in a combination that improves multiple parameters, such as inductance, direct current resistance, number of turns, temperature, and inductor size. For example, the number of turns can be increased by 165% and the inductance can be increased by a 270% compared to a conventional inductor that has the same size. As another example, the number of turns can be increased by 135% and the inductance can be increased by 185% compared to a conventional inductor that has the same direct current resistance. As yet another example, the volume of the inductor can be reduced by 50% compared to a conventional inductor that has the same direct current resistance and inductance. As a final example, the temperature of the inductor can be reduced by about 60% compared to a conventional inductor that has the same inductance and size.

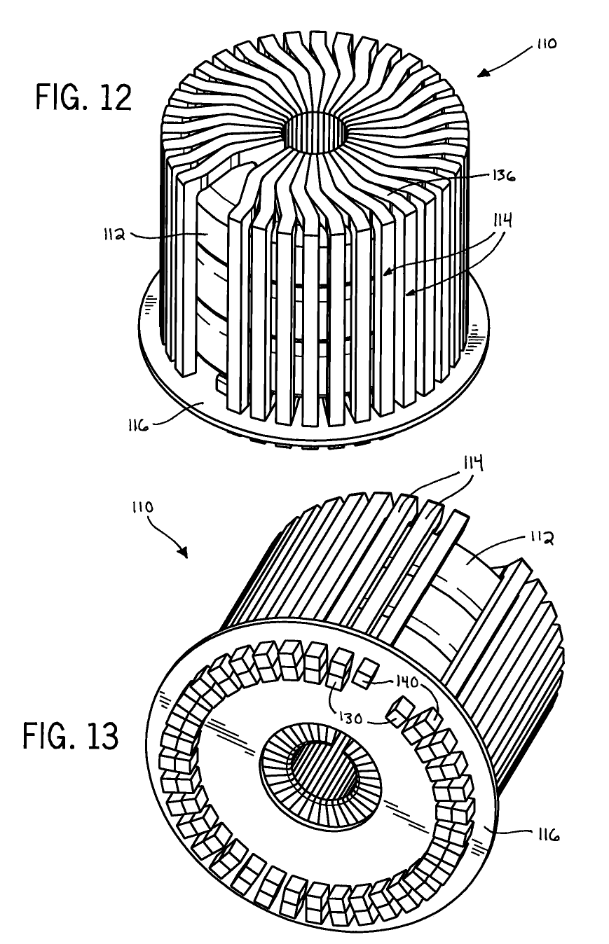

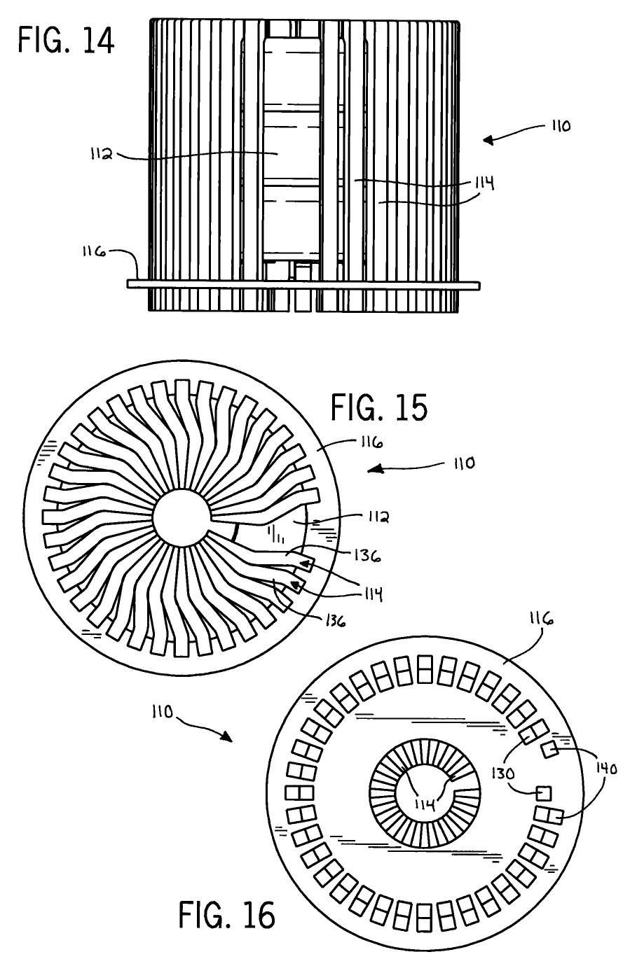

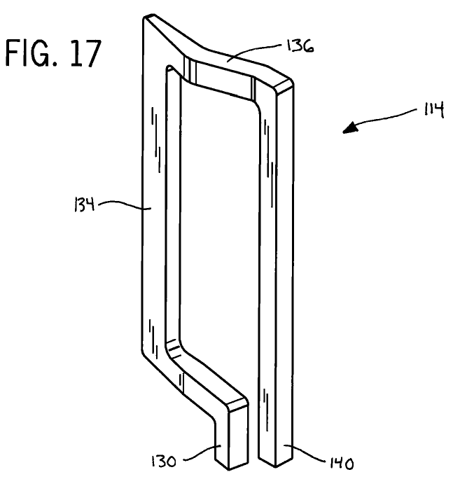

Although the wire segments 14 have been described above as having circular cross sections, different cross-sectional shapes may be used without departing from the scope of the invention. For example, the embodiment of the inductor 110 shown in FIGS. 12-16 includes wire segments 114 with rectangular cross sections. In addition to this difference in shape, the wire segments 114 differ from those described above because the upper lengths 136 include a sharply bent or “zig-zag” shape in order to provide an offset between the first and second legs 130 and 140 of each wire segment 114. Other features of the wire segments 114 may be as described above, and other components of the inductor 110, such as the magnetic core 112 and the base 116 may be as described above, except the base 116 preferably does not include single and double leg supports.

The inductor 110 may be manufactured generally as described above, except the wire segments 114 are preferably stamped components. The sharply bent upper length 136 and the pinched inner length 134, if included, may be provided by the stamping operation itself or a subsequent operation.

From the above disclosure, it should be apparent that the inductor of the invention may provide any combination of the following advantages: higher maximum current rating, smaller size, increased inductance, lower temperature rise, and simplified assembly compared to inductors using traditional winding methods and materials.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

We claim:

1. An inductor, comprising:
a magnetic core including at least one core segment; and
a plurality of separate conductive wire segments together forming a current path around at least a portion of the magnetic core, each segment forming a turn around a portion of the magnetic core and the segments being connected end-to-end to form the current path, a first of the plurality of wire segments including a first leg and a second leg, a second of the plurality of wire segments including a first leg adjacent the first leg of the first wire segment but not in electrical contact therewith, and the second wire segment further including a second leg adjacent the second leg of the first wire segment but not in electrical contact therewith, and the second leg of the second wire segment being in electrical contact with the first leg of the first wire segment to electrically connect the first and second wire segments.

2. The inductor of claim 1, further comprising a base including a plurality of holes that accommodate the first and second legs of the first and second wire segments.

3. The inductor of claim 2, further comprising a support within each hole in the base, a first of the supports including a hole that accommodates the first leg of the first wire segment and the second leg of the second wire segment.

4. The inductor of claim 3, wherein the hole in the first of the supports is defined by two overlapping circular holes.

5. The inductor of claim 1, wherein the magnetic core has a toroidal shape, and the first and second legs of the first wire segment are radially and angularly offset from each other relative to a longitudinal axis defined by the magnetic core.

6. The inductor of claim 5, wherein the first leg of the first wire segment and the second leg of the second wire segment are angularly aligned and radially offset from each other relative to the longitudinal axis.

7. The inductor of claim 1, wherein the magnetic core has a toroidal shape including an inner radial surface, and wherein each of the wire segments has a pinched area proximate the inner radial surface permitting the wire segments to be closely positioned to one another.

8. The inductor of claim 1, wherein legs of the first and second wire segments include a longitudinal surface, and wherein the longitudinal surfaces of the first leg of the first wire segment and the second leg of the second wire segment are in contact with one another.

9. The inductor of claim 1, wherein the magnetic core has a toroidal shape including an outer radial surface and a lower axial surface, the first legs of the first and second wire segments being disposed adjacent the lower axial surface, and the second legs of the first and second wire segments being disposed radially outwardly relative to the first legs.

10. An inductor, comprising:
a magnetic core including at least one core segment, and the magnetic core having:
an outer surface;
an inner surface;
an upper surface connecting the outer surface and the inner surface;
a lower surface opposite the upper surface; and
a plurality of separate conductive wire segments together forming a current path around at least part of the magnetic core, a first of the plurality of wire segments forming a first turn in the current path, the first turn proceeding from a first leg, extending around a portion of the magnetic core defined by the lower surface, the inner surface, the upper surface, and the outer surface, and ending at a second leg proximate the first leg, a second of the plurality of wire segments forming a second turn in the current path, the second turn proceeding from a first leg, extending around another portion of the magnetic core defined by the lower surface, the inner surface, the upper surface, and the outer surface, and ending at a second leg proximate the first leg of the second wire segment, the second leg of the second wire segment being electrically connected to the first leg of the first wire segment.

11. The inductor of claim 10, wherein the first leg of the first wire segment is at least one of soldered and crimped to the second leg of the second wire segment.

12. The inductor of claim 10, wherein the first and second wire segments are identical components.

13. The inductor of claim 10, further comprising a base having a plurality of holes, a first of the holes accommodating the second leg of the first wire segment, a second of the holes accommodating the first leg of the first wire segment and the second leg of the second wire segment, and a third of the holes accommodating the first leg of the second wire segment.

14. An inductor, comprising:
a magnetic core including at least one core segment;
a plurality of separate conductive wire segments together forming a current path around at least a portion of the magnetic core, each of the wire segments including a first leg and a second leg; and
an insulating base including a plurality of holes to accommodate the first and second legs of the wire segments, at least some of the holes each accommodating and permitting contact between the first leg of one wire segment and the second leg of an adjacent wire segment to electrically connect the one wire segment and the adjacent wire segment.

15. The inductor of claim 14, wherein the magnetic core has a toroidal shape including an outer radial surface and an inner radial surface, each of the wire segments includes an outer length proximate the outer radial surface that defines a nominal dimension, each of the wire segments further includes an inner pinched area proximate the inner radial surface, centers of adjacent inner pinched areas are spaced apart by a first distance, and the first distance is less than the nominal dimension.

16. The inductor of claim 15, wherein the plurality of holes in the base define at least a portion of a circular pattern on the base.

17. The inductor of claim 16, wherein the first and second legs accommodated in each hole of the base are angularly aligned and radially offset with each other relative to a longitudinal axis defined by the magnetic core.

18. The inductor of claim 14, further comprising a support within each hole in the base, at least some of the supports each including a hole that accommodates and permits contact between the first leg of one wire segment and the second leg of an adjacent wire segment to electrically connect the one wire segment and the adjacent wire segment.

19. The inductor of claim 14, further comprising a support within each hole in the base, at least some of the supports each including two overlapping circular holes, one of the overlapping circular holes accommodating the first leg of one wire segment, and the other of the overlapping circular holes accommodating the second leg of an adjacent wire segment to electrically connect the one wire segment and the adjacent wire segment.
